(19) United States
(12) Patent Application Publication
(10) Pub. No.: US 2025/0077269 A1
(43) Pub. Date: Mar. 6, 2025

(54) COMMAND TO INITIATE A COMPONENT SWAP

(71) Applicant: INTERNATIONAL BUSINESS MACHINES CORPORATION, Armonk, NY (US)

(72) Inventors: Pasquale A. CATALANO, Wallkill, NY (US); Michael James BECHT, Poughkeepsie, NY (US); Christopher J COLONNA, Ossining, NY (US); Stephen Robert GUENDERT, Murfreesboro, TN (US)

(21) Appl. No.: 18/456,622

(22) Filed: Aug. 28, 2023

(51) Int. Cl. G06F 9/48

(52) U.S. Cl. CPC G06F 9/48

(57) ABSTRACT

A receiving network device obtains a command built to enable a control program to initiate a swap of one or more components of a network. The command includes an indication of the one or more components for which the swap is to be initiated. The receiving network device initiates the swap of the one or more components indicated by the command, and provides status resulting from the initiation of the swap of the one or more components.

### BACKGROUND

One or more aspects relate, in general, to facilitating processing within a computing environment, and in particular, to facilitating communication within the computing environment.

Certain computing environments use storage area networks to provide access between devices. For example, a storage area network provides data paths between one or more host devices and one or more storage devices. The data paths may include network devices, such as switches, and/or other devices, as well as communication links. The links may be fiber optic or other types of cables or even wireless.

A device, such as a network device, has various components, including ports used to receive and/or transmit data (e.g., via optical transceivers), as well as other components. For example, a network device and/or a network, such as a storage area network, may include blades, such as server blades and/or other blades.

A server blade typically includes a single server, often dedicated to a single application, and includes, for instance, processors, memory, integrated network controllers, an optional host bus adapter (e.g., Fibre Channel host bus adapter) and other input/output ports. A server blade may be part of a blade server, which is a compact device that includes a computer used to manage and distribute data in a collection of computers and systems, such as a storage area network. A blade server includes, for instance, one or more thin, modular electronic circuit boards, known as server blades.

The proper functioning of the components of a network, such as ports and/or blades, facilitates optimal functioning of the network.

### SUMMARY

Shortcomings of the prior art are overcome, and additional advantages are provided through the provision of a computer program product for facilitating processing within a computing environment. The computer program product includes one or more computer readable storage media and program instructions collectively stored on the one or more computer readable storage media. The program instructions include program instructions to obtain, by a receiving network device, a command built to enable a control program to initiate a swap of one or more components of a network. The command includes an indication of the one or more components for which the swap is to be initiated. The program instructions collectively stored further include program instructions to initiate, by the receiving network device, the swap of the one or more components indicated by the command, and program instructions to provide, by the receiving network device, status resulting from the swap of the one or more components.

Computer-implemented methods and systems relating to one or more aspects are also described and claimed herein. Further, services relating to one or more aspects are also described and may be claimed herein.

Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to incorporate, perform and/or use one or more aspects of the present disclosure;

FIG. 2 depicts one example of aspects of a storage area network to incorporate, perform and/or use one or more aspects of the present disclosure;

FIG. 3A depicts one example of sub-modules of an initiate swap module of FIG. 1, in accordance with one or more aspects of the present disclosure;

FIG. 3B depicts one example of sub-modules of a command build/send sub-module of the initiate swap module of FIG. 3A, in accordance with one or more aspects of the present disclosure;

FIG. 3C depicts one example of sub-modules of a command receive/initiate swap sub-module of the initiate swap module of FIG. 3A, in accordance with one or more aspects of the present disclosure;

FIG. 4 depicts one example of a command build/send process, in accordance with one or more aspects of the present disclosure;

FIG. 5A depicts one example of a control unit port command to initiate a component swap, in accordance with one or more aspects of the present disclosure;

FIG. 5B depicts one example of information transmitted based on the control unit port command of FIG. 5A, in accordance with one or more aspects of the present disclosure; and

FIG. 6 depicts one example of a command receive/initiate swap process, in accordance with one or more aspects of the present disclosure.

### DETAILED DESCRIPTION

In accordance with one or more aspects of the present disclosure, a capability is provided to facilitate processing within a computing environment. In one aspect, the capability includes facilitating communication within the computing environment by improving the use of components of a network, such as a storage area network used to provide data paths between host devices and storage devices.

In one example, to improve utilization of selected components of a storage area network (or other networks), such as ports of, e.g., network devices (e.g., switches, directors, appliances, etc.) that receive and/or transmit data and/or blades used to provide computing and/or storage resources for the storage area network, a swap capability is provided to swap one component for another component, such as one port for another port or one blade for another blade, as examples. Although, example components of a storage area network are provided, a storage area network may have additional, fewer and/or other components, including additional, fewer and/or other swappable components. Many examples are possible.

A component swap is initiated based on, e.g., a command built and sent from one device, e.g., a host device, to another device, e.g., a receiving network device. The command is built by, using and/or on behalf of a control program (e.g., an operating system, other control program, etc.) to enable the control program to initiate a swap. The receiving network device receives the command and based on a command structure of the command, initiates a swap. In one example, the network device is part of a storage area network, and the device building/transmitting the command may be part of the storage area network, or separate therefrom and coupled to one or more devices of the storage area network.

One or more aspects of the present disclosure are incorporated in, performed and/or used by a computing environment. As examples, the computing environment may be of various architectures and of various types, including, but not limited to: personal computing, client-server, distributed, virtual, emulated, partitioned, non-partitioned, cloud-based, quantum, grid, time-sharing, cluster, peer-to-peer, wearable, mobile, having one node or multiple nodes, having one processor or multiple processors, and/or any other type of environment and/or configuration, etc. that is capable of executing a process (or multiple processes) that, e.g., initiates a swap and/or performs one or more other aspects of the present disclosure. Aspects of the present disclosure are not limited to a particular architecture or environment.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

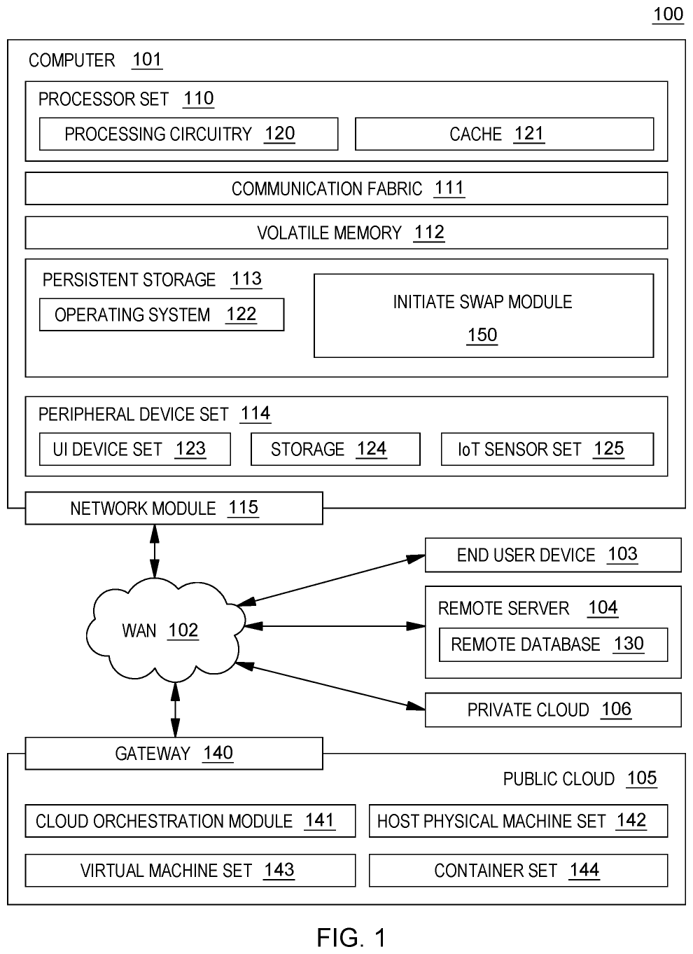

One example of a computing environment to perform, incorporate and/or use one or more aspects of the present disclosure is described with reference to FIG. 1. In one example, a computing environment 100 contains an example of an environment for the execution of at least some of the computer code involved in performing the inventive methods, such as initiate swap code or module 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The computing environment described above is only one example of a computing environment to incorporate, perform and/or use one or more aspects of the present disclosure. Other examples are possible. For instance, in one or more embodiments, one or more of the components/modules of FIG. 1 are not included in the computing environment and/or are not used for one or more aspects of the present disclosure. Further, in one or more embodiments, additional and/or other components/modules may be used. Other variations are possible.

Further details relating to one or more components/modules of FIG. 1 used in accordance with one or more aspects of the present disclosure are described herein. For example, storage 124 is provided, in one example, by a storage network, such as a storage area network (SAN). In one example, a storage area network includes a plurality of devices coupled to one another via a plurality of connections. As examples, the plurality of devices includes one or more endpoint devices (e.g., one or more servers, such as computer(s) 101; one or more processors and/or nodes of a processor set (e.g., processor set 110); one or more remote servers, such as remote server(s) 104; and/or one or more end user devices, such as end user device(s) 103; etc.), one or more network devices (e.g., switches, directors, appliances, etc.), one or more storage devices, and/or one or more other devices; and the connections include, for instance, links and/or other connections. Many examples are possible.

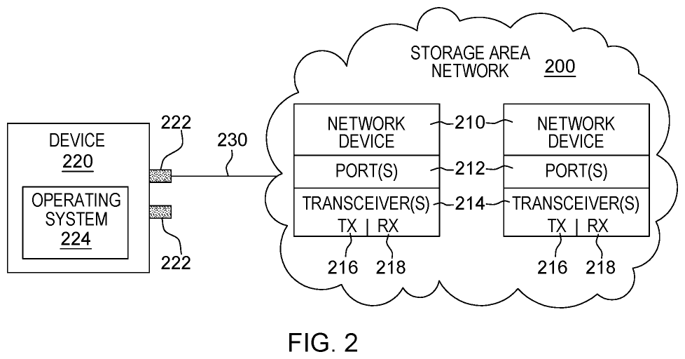

One example of network devices of a storage area network is described with reference to FIG. 2. In one example, a storage area network 200 includes one or more network devices 210, such as one or more switches, directors, appliances, etc. As examples, one or more of network devices 210 support the Fibre Channel and/or Fibre Channel over Ethernet protocols. Although the Fibre Channel and/or Fibre Channel over Ethernet protocols are specified herein, one or more of the network devices may support other protocols. Fibre Channel and/or Fibre Channel over Ethernet protocols are just examples. Further, in one or more examples, storage area network 200 may include a network fabric, such as a switched fabric, which includes, for instance, a plurality of network devices (e.g., directors or switches based on fibre technology, other directors or switches and/or other network devices) coupled to one another via one or more connections (e.g., inter-switch links, other links and/or other connections). Various examples are possible.

Each network device 210 includes, for instance, one or more ports 212 that connect a network device to one or more other devices, including one or more other network devices and/or one or more other devices (referred to herein as non-network devices) via one or more links. A port (e.g., port 212) may receive and/or transmit data. In one example, a port (e.g., port 212) may include one or more transceivers (e.g., transceivers 214) to transmit (TX) 216 and/or receive (RX) 218 data. The transceivers may be, for instance, pluggable, optical transceivers that plug into the port(s).

In one example, one or more of network devices 210 is coupled to a device 220 via one or more links 230. As examples, the device may be a computer, such as computer 101 or other computer; a processor or node, such as a processor or node of processor set 110 or other processor or node; a remote server, such as remote server 104 or other remote server; an end user device, such as end user device 103 or other end user device; or other non-network devices of a computing environment, such as computing environment 100. The device also includes, in one example, one or more ports 222 that connect the device to one or more network devices 210 and/or to other non-network devices. In one example, ports 222 of device 220 and/or of at least some other non-network devices (such as other endpoint devices, etc.) are referred to, in one example, as channel ports, while ports 212 of network device 210 are referred to, for instance, as switch ports. Other examples are possible.

In one example, device 220 is separate but coupled to the storage area network. In another example, it is part of the storage area network. In one example, device 220 includes an operating system 224 or another control program that sends commands from the device to, e.g., a network device. In one example, the device (e.g., device 220) is a host device. Other examples and/or variations are possible.

The storage area network of FIG. 2 is only one example. Storage area networks may include additional, fewer and/or other devices (e.g., network devices, non-network devices, etc.), ports and/or connections. Many examples and variations are possible. For instance, the number, type and interconnections of the devices and connections in each storage area network may be different. Further, storage area networks may support other transmission protocols. Again, many variations are possible.

In one example, to improve processing of and/or related to a storage area network (e.g., storage area network 200), one or more components of the storage area network may be swapped. Example components that may be swapped include, for instance, a port (physical or logical), a blade, and/or other swappable components. As examples, if a port or blade is to have maintenance performed thereon, is to be repaired or replaced, etc., then the port or blade is swapped, as described herein.

In one or more aspects, initiation of a component swap may be triggered based on, for instance, a command indicating the initiation of a swap. In one or more aspects, the command may be built, transmitted and received using a module, such as an initiate swap module (e.g., initiate swap module 150 of FIG. 1) that includes code or instructions used to initiate a swap, in accordance with one or more aspects of the present disclosure.

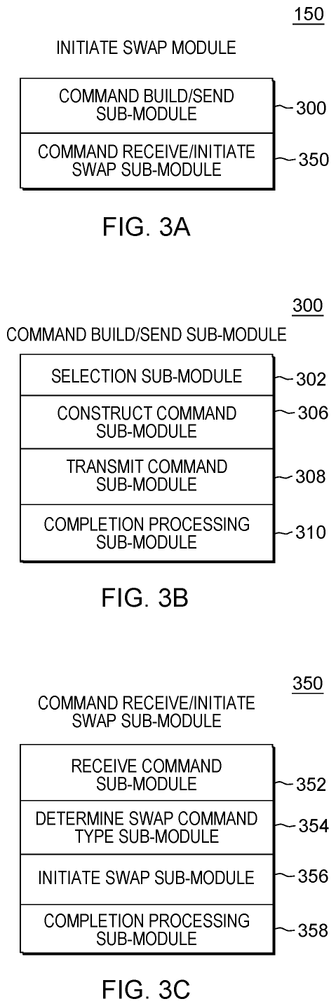

In one or more aspects, referring to FIG. 3A, an initiate swap module (e.g., initiate swap module 150) includes, in one example, various sub-modules to be used to initiate a swap and/or to perform tasks relating thereto. The sub-modules are, e.g., computer readable program code (e.g., instructions) in computer readable media, e.g., storage (persistent storage 113, cache 121, storage 124, other storage, as examples). Although, as an example, initiate swap module 150 is depicted in FIG. 1 in persistent storage 113, one or more sub-modules may be in other storage, such as storage 124, etc. Many variations are possible.

The computer readable media may be part of one or more computer program products and the computer readable program code may be executed by and/or using one or more devices (e.g., one or more computers, such as computer(s) 101; one or more servers, such as remote server(s) 104; one or more end user devices, such as end user device(s) 103; one or more processors or nodes, such as processor(s) or node(s) of processor set 110; processing circuitry, such as processing circuitry 120 of processor set 110; one or more network devices (e.g., networks devices 210 (FIG. 2)); and/or other devices, etc.). Additional and/or other computers, servers, end user devices, processors, nodes, processing circuitry, network devices and/or other devices may be used to execute one or more of the sub-modules and/or portions thereof. Many examples are possible.

Example sub-modules of initiate swap module 150 include, for instance, a command build/send sub-module 300 to build a control unit port command to be used to initiate a swap and to send the command to a receiving device (e.g., a receiving network device); and a command receive/initiate swap sub-module 350 to receive the command and trigger initiation of a swap. Additional, fewer and/or other sub-modules may be used to implement the initiate swap processing. Other variations are possible. Although various sub-modules are described, an initiate swap module, such as initiate swap module 150, may include additional, fewer and/or different sub-modules. A particular sub-module may include additional code, including code of other sub-modules, less code, and/or different code. Further, additional and/or other modules may be used to initiate a swap and/or perform related tasks. Many variations are possible.

Further details relating to command build/send sub-module 300 are described with reference to FIG. 3B and further details relating to command receive/initiate swap sub-module 350 are described with reference to FIG. 3C. In one example, command build/send sub-module 300 is executed on one or more non-network devices, such as device(s) 220, and command receive/initiate swap sub-module 350 is executed on one or more network devices, such as network device(s) 210. In one example, a non-network device (e.g., non-network device 220) executing the command build/send sub-module is coupled to, but separate and independent of a network device (e.g., network device 210) executing the command receive/initiate swap sub-module. Other examples/variations are possible.

Referring to FIG. 3B, in one example, command build/send sub-module 300 includes a selection sub-module 302 to be used to select one or more target components to be swapped and one or more destination components to be swapped for the one or more target components; a construct command sub-module 306 to be used to build a command, such as a control unit port command, to initiate a swap; a transmit command sub-module 308 to be used to send the built command (e.g., control unit port command) to a receiving device (e.g., a receiving network device 210); and a completion processing sub-module 310 to obtain completion information from the receiving network device and/or perform one or more completion tasks based on the swap. Additional, fewer and/or other sub-modules may be used to implement the command build/send processing. Other variations are possible.

Referring to FIG. 3C, in one example, command receive/initiate swap sub-module 350 includes a receive command sub-module 352 to be used to receive the built command (e.g., control unit port command) at the receiving network device (e.g., a network device 210); determine swap command type sub-module 354 to determine a type of the component to be swapped (e.g., port, blade, other swappable component); an initiate swap sub-module 356 to initiate a swap of one or more components (e.g., target components) with one or more other components (e.g., destination components); and completion processing sub-module 358 to be used, e.g., to send completion status to the sending device. Additional, fewer and/or other sub-modules may be used to implement the command receive/initiate swap processing. Other variations are possible.

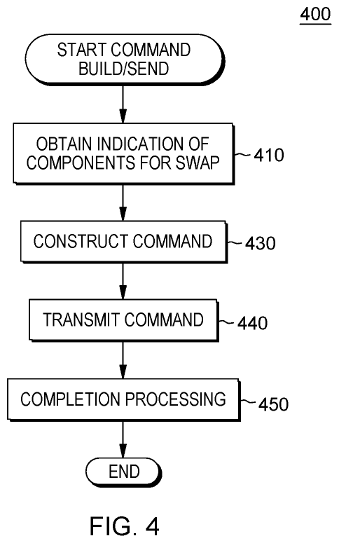

One or more of the sub-modules are used, in accordance with one or more aspects of the present disclosure, to build a command and to transmit the command to initiate a swap and/or to perform other tasks related thereto, as further described with reference to FIG. 4. In one example, a command build/send process (e.g., a command build/send process 400) is implemented using one or more of the sub-modules (e.g., one or more of sub-modules 300-310) and is executed by a device, such as device 220. In one example, device 220 is a computing device (e.g., computer (e.g., computer 101, other computer, etc.), a server (e.g., server 104, other server, etc.), an end user device (e.g., end user device 103), a processor, node and/or processing circuitry, etc. (e.g., of processor set 110 or other processor sets), and/or one or more other computing devices, etc.). Although example devices, computers, servers, end user devices, processors, nodes, processing circuitry and/or computing devices are provided, additional, fewer and/or other computers, servers, end user devices, processors, nodes, processing circuitry and/or computing devices may be used for the command build/send process and/or other processing. Various options are possible.

In one example, one or more aspects of command build/send process 400 (also referred to as process 400) are implemented and/or executed by, on behalf of and/or using a control program (e.g., operating system 224), other control programs, other operating systems and/or other applications executing on a device, such as device 220 and/or other devices. The device (e.g., device 220) executing the control program (e.g., operating system 224) to build and send the command is coupled to, but separate from, a network device (e.g., network device 210) receiving the command and initiating a component swap. In one example, the operating system (e.g., operating system 224) of the transmitting device (e.g., non-network device 220) is the z/OS® operating system offered by International Business Machines Corporation, Armonk, New York. The z/OS operating system, however, is only one example operating system; other operating systems of International Business Machines Corporation and/or other entities/companies may include and/or use one or more aspects of the present disclosure. z/OS is a trademark or registered trademark of International Business Machines Corporation in at least one jurisdiction.

In one example, the command being built and transmitted is an architected command of a selected architecture. As an example, the selected architecture is the z/Architecture® instruction set architecture offered by International Business Machines Corporation, Armonk, New York. One embodiment of the z/Architecture instruction set architecture is described in a publication entitled “IBM® z/Architecture-Principles of Operation,” SA22-7832-13, Fourteenth Edition, May 2022, which is hereby incorporated herein by reference in its entirety. The z/Architecture instruction set architecture, however, is only one example architecture; other architectures and/or other types of computing environments of International Business Machines Corporation and/or of other entities/companies may include and/or use one or more aspects of the present disclosure. The z/Architecture instruction set architecture and the z/OS operating system are only examples and are not meant to be limiting in any way. z/Architecture and IBM are trademarks or registered trademarks of International Business Machines Corporation in at least one jurisdiction.

In one example, referring to FIG. 4, process 400 obtains 410 an indication of components to be part of a swap. For example, one or more target components to be swapped with one or more destination components are determined and provided to process 400. The components may be, for instance, ports, blades and/or other swappable components of, e.g., a storage area network. The selections may be performed by, for instance, a user at a device, such as device 220, via, e.g., an operating system (e.g., operating system 224) or the selections may be determined by the host (e.g., operating system) or other application, control program, etc. In one example, the control program (e.g., operating system 224) executing on the non-network device (e.g., non-network device 220) determines, based on information it possesses or obtains (e.g., input/output (I/O) configuration data, potential or actual I/O configuration changes, performance data, etc.), that it would be beneficial to initiate a component swap. Other examples are possible.

The components selected for the swap (e.g., the target components and/or the destination components) may be selected periodically, randomly, based on a schedule, based on a performance concern or a perceived performance concern or any other reason.

Process 400 constructs 430 a command, such as a control unit port command, to initiate a swap of one or more target components with one or more destination components. For instance, the process (e.g., using the operating system) constructs the control unit port command using the selected components. In one example, it populates a command structure of the command, an example of which is described below, with, e.g., one or more identifiers of one or more components to be swapped and/or one or more identifiers of one or more destination components for the swap. Other examples are possible.

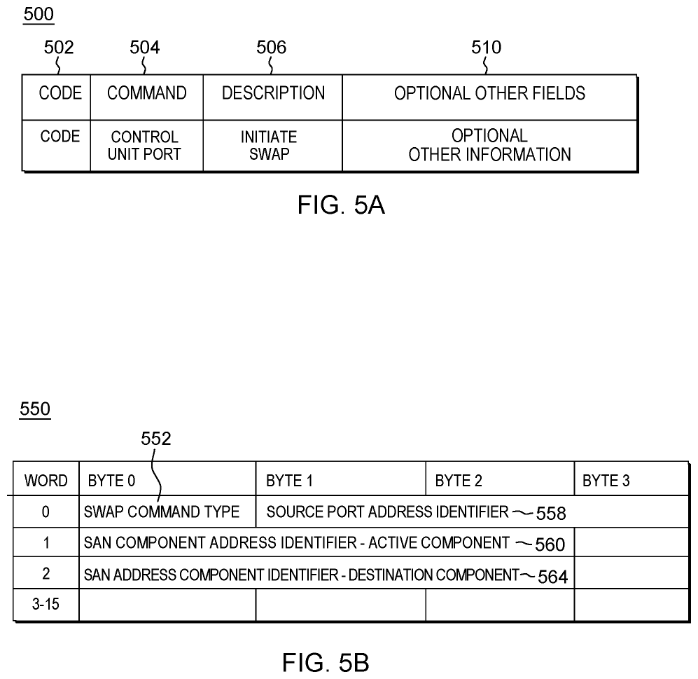

One example format of a command to be constructed is depicted in FIG. 5A. As shown, in one example, a command format 500 includes a code field 502, which includes a unique code identifying the command; a command field 504, which indicates the command, such as a control unit port command (and may or may not specify what action the command is performing); a description field 506, which provides a description of the command, such as initiate swap; and optionally, there may be one or more other fields 510. As examples, the one or more other fields may include one or more of a test key and increment field, which indicates whether a test key and increment command with an equal test comparison is to be included in the same channel command word chain prior to this command; an identify field, which indicates whether an identify command is to be included in the same channel command word chain prior to this command; an accepted with host control prohibited field, which indicates whether this command will be accepted or not when host control is prohibited; and/or a count field, which indicates an amount of data to be transferred. Additional, fewer and/or other fields are possible. Other command formats are also possible. The command format may include additional, fewer and/or other fields/information. Many variations are possible.

One example of the information transferred using the control unit port command is described with reference to FIG. 5B. As examples, a component swap may be triggered for one or more components, and the command structure reflects that and/or one or more command structures may be used. Various examples are possible.

In one example, a command structure 550 includes:
Swap Command Type 552 (byte 0 of word 0): This field indicates the type of component to be swapped. For instance, it may indicate a Swap Port to swap a single port; a Swap Blade to swap a single blade; a Swap Ports to swap a plurality of ports; a Swap Blades to swap a plurality of blades; and/or an indication or indications of another component or components to be swapped. For example, it may include a set of bits, one for each type of component and based on the bit set to a particular value, e.g., a one, that type of component is being swapped. It may include a mask to represent a variety of possibilities. Many examples of are possible.
Source Port Address Identifier 558 (e.g., bytes 1-3 of word 0): This field includes information regarding the port on the endpoint side. For instance, an identifier of the port used to transmit the command.
Storage area network (SAN) Component Address Identifier-Active Component 560 (e.g., bytes 0-2 of word 1): This field includes, for instance, a 3 byte address identifying a component (e.g., a target component) to be swapped. For instance, it includes an address of a port/blade (or other swappable component) and, e.g., the channel to which it is currently attached. In other examples, one or more addresses of one or more target components may be specified. Other examples are possible.
Storage area network (SAN) Component Address Identifier-Destination Component 564 (e.g., bytes 0-2 of word 2): This field includes, for instance, a 3 byte address identifying a component to swap for the component identified by active component 560. For instance, it includes an address of a port/blade (or other swappable component) and, e.g., the channel to which it is attached, which is to be swapped for the active component 560. As examples, a port identified by address 560 is swapped with a target port identified by address 564; a blade identified by address 560 is swapped with a target blade identified by address 564; etc. Other examples are possible.

In other examples, one or more addresses of one or more destination components may be specified.

Although in the example information described herein, specific words/bytes/bits are indicated for the fields, other words/bytes/bits may be used for the specific fields. Further, although the words/bytes/bits are set to specific values for one purpose or another, the words/bytes/bits may be set to the opposite values and/or different values. The particular words/bytes/bits and/or values described herein are just examples. Further, one or more fields may be left blank, ignored and/or not included in the command structure. Moreover, other example information and/or command structures may include additional, fewer, and/or other fields. Many variations and examples are possible.

Returning to FIG. 4, in one example, process 400 transmits 440 the built command to a receiving device. For instance, process 400 transmits the command from, e.g., the operating system (e.g., operating system 224) to a selected receiving network device (e.g., a selected network device 210 (e.g., a switch, director, appliance, etc.)) using, e.g., a local port (e.g., a port 222) and one or more links (e.g., links 230). The receiving network device receives the command (e.g., using a port (e.g., a port 212)) and based on the command initiates the swap of one or more components of the storage area network (e.g., of one or more network devices and/or other components) based on the components identified in the command. As examples, the receiving network device performs the swap and/or instructs another device of, e.g., the storage area network to perform the swap. Various examples are possible.

In one example, process 400 performs 450 completion processing. As an example, process 400 obtains a completion indication from, e.g., the network device that received the command. For instance, the receiving network device initiates a swap, based on the command, and provides an indication of when the swap is complete (and/or when initiation is complete). For example, the receiving network device initiates a swap, and based on, e.g., completion of the swap, sends a completion indication to the transmitting device. In another example, the receiving network device initiates the swap by sending the command to one or more other devices (e.g., network devices), and based thereon, receives one or more completion indications from the one or more other devices and forwards the one or more completion indications and/or a completion summary indication summarizing completion status of the swap to the sending device. A completion indication may indicate whether the swap(s) completed successfully. If unsuccessful, the completion indication may specify one or more errors. As examples, the completion indications and/or status may be sent to the transmitting device via, e.g., a message, a signal, one or more fields of the command structure, etc. Other variations and examples are possible.

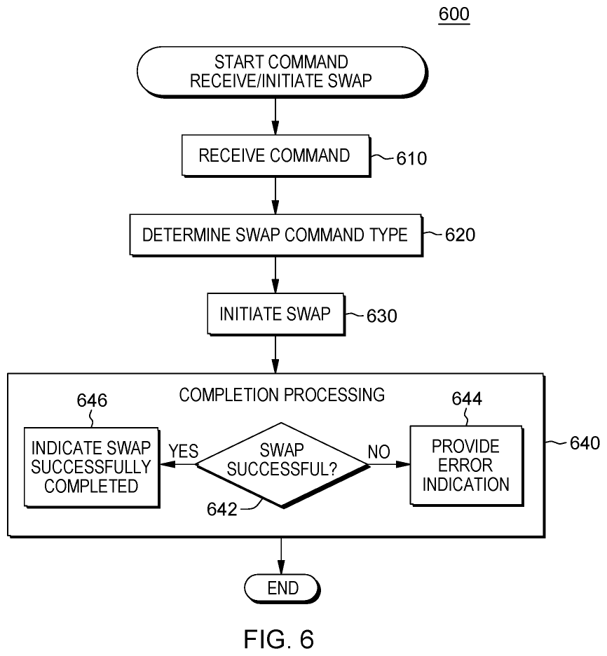

In one example, the constructed command is received at the receiving device (e.g., a receiving network device 210) in order to initiate a swap of one or more components. In one example, one or more sub-modules are used, in accordance with one or more aspects of the present disclosure, to receive the command, initiate the swap and/or perform other tasks related thereto, as described with reference to FIG. 6. In one example, a command receive/initiate swap process (e.g., a command receive/initiate swap process 600) is implemented using one or more of the sub-modules (e.g., one or more of sub-modules 350-358) and is executed by one or more devices, such as one or more network devices 210, as described herein. In one example, network device 210 includes a switch, a director, an appliance and/or another network device. A network device may have processing circuitry. In other examples, other devices, other than network devices, may also receive an initiate swap command and perform one or more actions to initiate a swap. In one example, the network device receiving the command may initiate a swap of an identified component of the storage area network (e.g., a component of that device or another component) and/or send the command, or an indication of the command, to one or more other network devices to initiate a swap of one or more components of the storage area network (e.g., one or more components of one or more other network devices or other components). Various options are possible.

In one example, process 600 executing on a device (e.g., network device 210) receives 610 the command and determines 620 a swap command type. For instance, process 600 checks swap command type field 552 of command structure 550 to determine the type of component/components to be swapped. For example, it determines whether the swap is of one or more ports, one or more blades and/or of one or more other components.

Further, process 600 initiates at least one swap 630 based on the swap command type field of the command. For instance, if swap command type field 552 indicates a swap of a port, process 600 running on the receiving network device swaps the port identified by storage area network component address identifier-active component 560 with the port identified by storage area network component address identifier-destination component 564. This includes, for instance, replacing the active address with the destination address, as one example. In another example, process 600 sends the command (or an indication of the command) to another device (e.g., another network device or another device of the storage area network) to perform the swap. Other variations are possible.

In another example, if the swap is a blade swap, then, in one example, the address of the active blade is changed to the address of the destination blade. This may be performed by the receiving network device or another device that receives the command or an indication of the command from the receiving network device. Other variations are possible, including the swapping of other swappable components.

In one example, based on the swap being completed, process 600 performs 640 completion processing. For example, process 600 determines 642 whether the swap successfully completed. For instance, process 600 obtains status information from the receiving network device, which may have received the status from one or more other devices. Based on the swap being unsuccessful, in one example, process 600 provides 644 an error indication to the transmitting device. In one example, the transmitting device is indicated in the command, such as via, e.g., a source port address identifier (e.g., source port address identifier 558). In one example, the receiving network device sends the error status to the transmitting device (e.g., device 220). As an example, operating system 224 receives this information. In another example, the command structure (e.g., command structure 550) has one or more fields for an error indication and/or status and the command structure, including the error indication/status, is returned to the transmitting device. Other examples are possible.

However, if the swap was successful 642, process 600 provides 646 an indication of successful completion to the transmitting device. For instance, process 600 obtains status information from the receiving network device, which may have received the status from one or more other devices. Based on the swap being successful, in one example, process 600 provides 646 an indication of successful completion to the transmitting device. In one example, the transmitting device is indicated in the command, such as via, e.g., a source port address identifier (e.g., source port address identifier 558). As an example, operating system 224 of the transmitting device (e.g., device 220) receives this information. In another example, the command structure (e.g., command structure 550) has one or more fields for an error indication and/or status and the command structure, including the error indication/status, is returned to the transmitting device. Other examples are possible.

Although in the examples herein, example components to be swapped are described, additional, fewer and/or other swappable components may be specified by the command.

In one example, the control program (e.g., operating system 224) of the transmitting device receives the response and may take action based on the response. For instance, it may perform and/or signal to deactivate a component, activate a component, mitigate traffic flow to, e.g., the port(s), etc.; initiate and/or perform replacement, repair and/or bypass of a particular component and/or device, etc. The action taken depends, for instance, on the received information and a determination of an approach to be implemented to, e.g., improve the network (e.g., storage area network) to facilitate communication and/or processing within the computing environment. Many variations are possible.

In one or more aspects, a capability is provided to build a command, such as a control unit port command, and send the command to a storage area network device (or other device) to initiate a swap of one or more components of, e.g., a storage area network. This enables another device, such as an operating system executing on the other device, to initiate a component swap, improving component operations, communications and processing within a computing environment. The operating system may run/initiate the command, which may be used with any network device (e.g., any switching product (e.g., FICON switching product)), regardless of vendor.

In one example, the operating system (e.g., operating system 224) is afforded the ability to use a structured command, architecturally defined, to initiate a swap of one or more components of a network. The request by the operating system may be programmatically sent based on information possessed, obtained, determined, perceived, etc. at the operating system side (i.e., not the network device side).

As an example, the command is built and sent by the operating system executing on a non-network device based on I/O configuration data, such as access to an I/O configuration data set, other I/O configuration information and/or performance data (e.g., related to data transmission, etc.). It allows one tool (e.g., the operating system) to have control of initiating the swap and when to initiate it. It allows the operating system to take action prior and/or subsequent to the swap since it has control of when to request the swap.

In one example, implementation and use of the command to initiate a swap of one or more components does not depend on or require knowledge of the specific vendor(s) of the network devices (e.g., of the storage area network) or of the original equipment manufacturer's management software (or others) used by the network devices. The command is not network device—or storage area network-vendor specific, allowing the command to be used by the operating system for network devices/components offered by various vendors.

One or more aspects of the present disclosure are tied to computer technology and facilitate processing within a computer, improving performance thereof. For instance, communication within a computing environment is improved by providing a capability to initiate a component swap of, e.g., one or more components of a storage area network. A capability is provided for the attached host device to inform one or more storage area network devices that a swap is to be initiated. Processing within a processor, computer system and/or computing environment is improved.

Other aspects, variations and/or embodiments are possible.

In addition to the above, one or more aspects may be provided, offered, deployed, managed, serviced, etc. by a service provider who offers management of customer environments. For instance, the service provider can create, maintain, support, etc. computer code and/or a computer infrastructure that performs one or more aspects for one or more customers. In return, the service provider may receive payment from the customer under a subscription and/or fee agreement, as examples. Additionally, or alternatively, the service provider may receive payment from the sale of advertising content to one or more third parties.

In one aspect, an application may be deployed for performing one or more embodiments. As one example, the deploying of an application comprises providing computer infrastructure operable to perform one or more embodiments.

As a further aspect, a computing infrastructure may be deployed comprising integrating computer readable code into a computing system, in which the code in combination with the computing system is capable of performing one or more embodiments.

Yet a further aspect, a process for integrating computing infrastructure comprising integrating computer readable code into a computer system may be provided. The computer system comprises a computer readable medium, in which the computer medium comprises one or more embodiments. The code in combination with the computer system is capable of performing one or more embodiments.

Although various embodiments are described above, these are only examples. For example, other techniques to indicate that a component swap is to be initiated may be used. Further, services and/or commands may be used to obtain component information to be used, e.g., to determine whether a swap is to be performed and/or swap component targets/destinations. Moreover, additional, less and/or other information may be transmitted using the control unit port command to initiate a swap. Further, the storage area network may be separate and/or different from storage 124. Yet further, other networks may use one or more aspects of the present invention. Many variations are possible.

Various aspects and embodiments are described herein. Further, many variations are possible without departing from a spirit of aspects of the present disclosure. It should be noted that, unless otherwise inconsistent, each aspect or feature described and/or claimed herein, and variants thereof, may be combinable with any other aspect or feature.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer program product for facilitating processing within a computing environment, the computer program product comprising:
one or more computer readable storage media and program instructions collectively stored on the one or more computer readable storage media, the program instructions collectively stored comprising:
program instructions to obtain, by a receiving network device, a command built to enable a control program to initiate a swap of one or more components of a network, the command including an indication of the one or more components for which the swap is to be initiated;
program instructions to initiate, by the receiving network device, the swap of the one or more components indicated by the command; and
program instructions to provide, by the receiving network device, status resulting from the swap of the one or more components.

2. The computer program product of claim 1, wherein the command further includes an indication of one or more destination components to be swapped in for the one or more components.

3. The computer program product of claim 1, wherein the command further includes an indication of at least one type of component of one or more types of components to be swapped.

4. The computer program product of claim 3, wherein the one or more types of components include ports and blades.

5. The computer program product of claim 1, wherein the program instructions to initiate the swap of the one or more components includes program instructions to forward at least an indication of the command to one or more network devices coupled to the receiving network device to initiate the swap of at least one component of the one or more components.

6. The computer program product of claim 1, wherein the command is a control unit port command constructed based on a defined format, the defined format including a command code, a command name and a description of the command.

7. The computer program product of claim 1, wherein the command uses a command structure built to be used with the command, the command structure provided to the receiving network device and including one or more identifiers of the one or more components to be swapped and one or more identifiers of one or more destination components to be swapped in for the one or more components.

8. The computer program product of claim 7, wherein the command structure further includes a swap command type indicating one or more types of components to be swapped.

9. The computer program product of claim 1, wherein the status includes an indication of whether the swap was successful.

10. The computer program product of claim 9, wherein based on the swap being unsuccessful, the status includes one or more error indications.

11. A computer system for facilitating processing within a computing environment, the computer system comprising:
a memory; and
at least one device coupled to the memory, wherein the computer system is configured to perform a method, the method comprising:
obtaining, by a receiving network device, a command built to enable a control program to initiate a swap of one or more components of a network, the command including an indication of the one or more components for which the swap is to be initiated;
initiating, by the receiving network device, the swap of the one or more components indicated by the command; and
providing, by the receiving network device, status resulting from the swap of the one or more components.

12. The computer system of claim 11, wherein the command further includes an indication of one or more destination components to be swapped in for the one or more components.

13. The computer system of claim 11, wherein the command further includes an indication of at least one type of component of one or more types of components to be swapped.

14. The computer system of claim 11, wherein the initiating the swap of the one or more components includes forwarding at least an indication of the command to one or more network devices coupled to the receiving network device to initiate the swap of at least one component of the one or more components.

15. The computer system of claim 11, wherein the command uses a command structure built to be used with the command, the command structure provided to the receiving network device, and wherein the command structure includes one or more identifiers of the one or more components to be swapped and one or more identifiers of one or more destination components to be swapped in for the one or more components.

16. A computer-implemented method of facilitating processing within a computing environment, the computer-implemented method comprising:
obtaining, by a receiving network device, a command built to enable a control program to initiate a swap of one or more components of a network, the command including an indication of the one or more components for which the swap is to be initiated;
initiating, by the receiving network device, the swap of the one or more components indicated by the command; and
providing, by the receiving network device, status resulting from the swap of the one or more components.

17. The computer-implemented method of claim 16, wherein the command further includes an indication of one or more destination components to be swapped in for the one or more components.

18. The computer-implemented method of claim 16, wherein the command further includes an indication of at least one type of component of one or more types of components to be swapped.

19. The computer-implemented method of claim 16, wherein the initiating the swap of the one or more components includes forwarding at least an indication of the command to one or more network devices coupled to the receiving network device to initiate the swap of at least one component of the one or more components.

20. The computer-implemented method of claim 16, wherein the command uses a command structure built to be used with the command, the command structure provided to the receiving network device, and wherein the command structure includes one or more identifiers of the one or more components to be swapped and one or more identifiers of one or more destination components to be swapped in for the one or more components.
